(19) United States
(12) Patent Application Publication
(10) Pub. No.: US 2013/0127899 A1
(43) Pub. Date: May 23, 2013

(54) APPARATUS AND METHOD FOR DYNAMIC FILM REVIEW ON AN E-BOOK

(71) Applicant: Jiunn-Sheng Yan, Taipei (TW)

(72) Inventor: Jiunn-Sheng Yan, Taipei (TW)

(21) Appl. No.: 13/301,262

(22) Filed: Nov. 21, 2011

(51) Int. Cl. G09G 5/00

(52) U.S. Cl. 345/619

(57) ABSTRACT

An apparatus and method for dynamic film preview on an e-book, the apparatus including: a first storage device, used for storing at least one film; and a dynamic film preview processing unit, having the functions of: reading a target film from the first storage device; fetching a plurality of pictures from the target film to set up a preview figure file; and displaying the pictures of the preview figure file on a background in an order.

### BACKGROUND OF THE INVENTION

1. Field of the Invention

The present invention relates to an apparatus and method for providing a film preview, especially to an apparatus and method for providing a dynamic film preview on an e-book by generating a preview figure file according to a film, and displaying the pictures of the preview figure file in an order.

2. Description of the Related Art

The common seen film preview manners on an e-book/e-magazine are as follows:

1. Fetch only one picture of a film, and put a play icon on the middle of the picture to form a preview picture as illustrated in FIG. 1. However, it is hard for a viewer to comprehend the film by viewing a single image presented by the preview picture.

2. Directly play a film. For example, when an e-book/e-magazine displays a page containing a film zone as illustrated in FIG. 2, the e-book/e-magazine will read a corresponding file of the film zone, and directly play the corresponding file. However, this manner will occupy much part of the system resources. What's more, as most e-books/e-magazines, when browsed, can only enlarge or shrink the whole display page, that is, the view area of the film zone cannot be adjusted independently, therefore are not convenient to users.

To solve the foregoing problem, a novel apparatus and method for film preview, capable of providing excellent film preview effect without occupying much system resources, is needed.

### SUMMARY OF THE INVENTION

One objective of the present invention is to disclose an apparatus for dynamic film preview on an e-book, capable of generating a preview figure file and a preview object according to a film, wherein the preview figure file contains a plurality of pictures from the film, and the preview object is a display component, which contains an access route information for reaching the preview figure file; and capable of displaying the pictures of the preview figure file in an order.

Another objective of the present invention is to disclose an apparatus for dynamic film preview on an e-book, capable of placing a plurality of preview objects on a background.

Another objective of the present invention is to disclose an apparatus for dynamic film preview on an e-book, capable of playing a film when a preview object corresponding to the film is selected on a background.

Another objective of the present invention is to disclose a method for dynamic film preview on an e-book, capable of generating a preview figure file and a preview object according to a film, wherein the preview figure file contains a plurality of pictures from the film, and the preview object is a display component, which contains an access route information for reaching the preview figure file; and capable of displaying the pictures of the preview figure file in an order.

Another objective of the present invention is to disclose a method for dynamic film preview on an e-book, capable of placing a plurality of preview objects on a background.

Still another objective of the present invention is to disclose a method for dynamic film preview on an e-book, capable of playing a film when a preview object corresponding to the film is selected on a background.

To attain the foregoing objectives, an apparatus for dynamic film preview on an e-book is proposed, the apparatus including a first storage device and a dynamic film preview processing unit.

The first storage device has a storage space for at least one film.

The dynamic film preview processing unit has the functions as follows: reading a target film from the first storage device; fetching a plurality of pictures from the target film to set up a preview figure file and a preview object, wherein the preview figure file contains the plurality of pictures, and the preview object is a display component containing an access route information for reaching the preview figure file; and displaying the pictures of the preview figure file in an order.

Preferably, the preview object further contains an access route information for reaching the target film, so as to make the dynamic film preview processing unit further possess a function of playing the target film in response to the selection of the preview object.

Preferably, the dynamic film preview processing unit selects the preview object according to a selection instruction, which is generated by operating a mouse, a keyboard, or a touch screen.

Preferably, the first storage device further has a storage space for the preview figure files.

Preferably, the first storage device is a hard disk device or a solid state storage device.

Preferably, the dynamic film processing unit has a central processing unit.

Preferably, the dynamic film preview processing unit has an operation system, which can be WINDOWS [symbol] UNIX [symbol] LINUX [symbol] MacOS [symbol] iOS [symbol] or Android.

To attain the foregoing objectives, another apparatus for dynamic film preview on an e-book is proposed, the apparatus including a first storage device, a dynamic film preview processing unit, and a second storage device.

The first storage device is used for storing at least one film.

The dynamic film preview processing unit has the functions as follows: reading a target film from the first storage device; fetching a plurality of pictures from the target film to set up a preview figure file and a preview object, wherein the preview figure file contains the plurality of pictures, and the preview object is a display component containing an access route information for reaching the preview figure file; and displaying the pictures of the preview figure file in an order.

The second storage device is used for storing the preview figure files.

Preferably, the preview object further contains an access route information for reaching the target film, so as to make the dynamic film preview processing unit further possess a function of playing the target film in response to the selection of the preview object.

Preferably, the dynamic film preview processing unit selects the preview object according to a selection instruction, which is generated by operating a mouse, a keyboard, or a touch screen.

Preferably, the first storage device is a hard disk device or a solid state storage device.

Preferably, the second storage device is a hard disk device or a solid state storage device.

Preferably, the dynamic film processing unit has a central processing unit.

Preferably, the dynamic film preview processing unit has an operation system, which can be WINDOWS [symbol] UNIX [symbol] LINUX [symbol] MacOS [symbol] iOS< or Android.

To attain the foregoing objectives, a method for dynamic film preview on an e-book is proposed, the method including the steps of:

fetching a plurality of pictures from a target film;

setting up a preview figure file and a preview object according to the plurality of pictures, wherein the preview figure file contains the plurality of pictures, and the preview object is a display component containing an access route information for reaching the preview figure file; and

displaying the pictures of the preview figure file on a background in an order.

Preferably, the preview object further contains an access route information for reaching the target film, so as to have the target film played when the preview object is selected.

Preferably, the method for dynamic film preview selects the preview object according to a selection instruction, which is generated by operating a mouse, a keyboard, or a touch screen.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a prior art preview picture having a play icon on the middle of a picture.

FIG. 2 illustrates a page of a prior art e-book/e-magazine containing a film zone.

FIG. 3(a) illustrates the block diagram of an apparatus for dynamic film preview on an e-book according to a preferred embodiment of the present invention.

FIG. 3(b) illustrates the block diagram of an apparatus for dynamic film preview on an e-book according to another preferred embodiment of the present invention.

FIG. 4 illustrates the flowchart of the method according to a preferred embodiment of the present invention.

FIG. 5(a) indicates that film A, film B, film C, and film D are fed in the dynamic film preview apparatus of the present invention.

FIG. 5(b) indicates that preview object A_{OBJ}, preview object B_{OBJ}, preview object C_{OBJ}, and preview object D_{OBJ} are generated by the dynamic film preview apparatus of the present invention according to film A, film B, film C, and film D.

FIG. 5(c) indicates that the dynamic film preview apparatus of the present invention plays film A in response to a user's selection instruction.

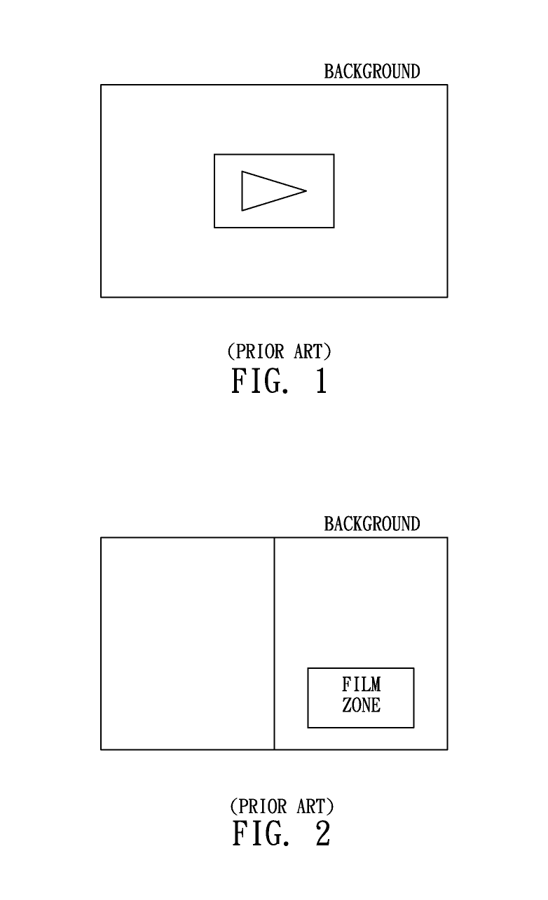

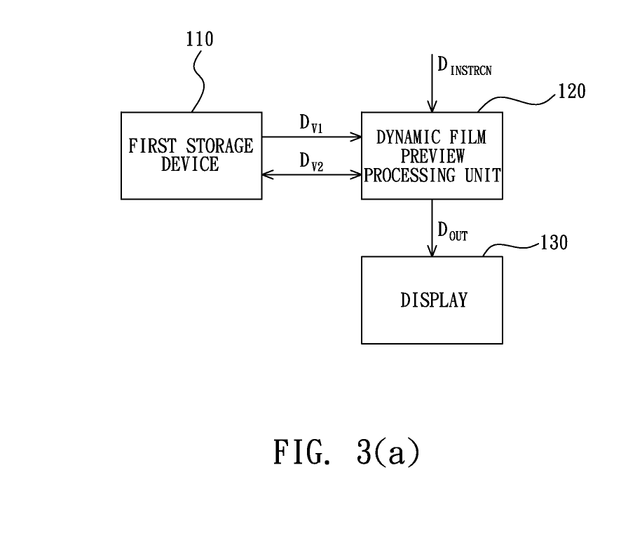

### DETAILED DESCRIPTION OF THE PREFERRED EMBODIMENTS

The present invention will be described in more detail hereinafter with reference to the accompanying drawings that show the preferred embodiments of the invention.

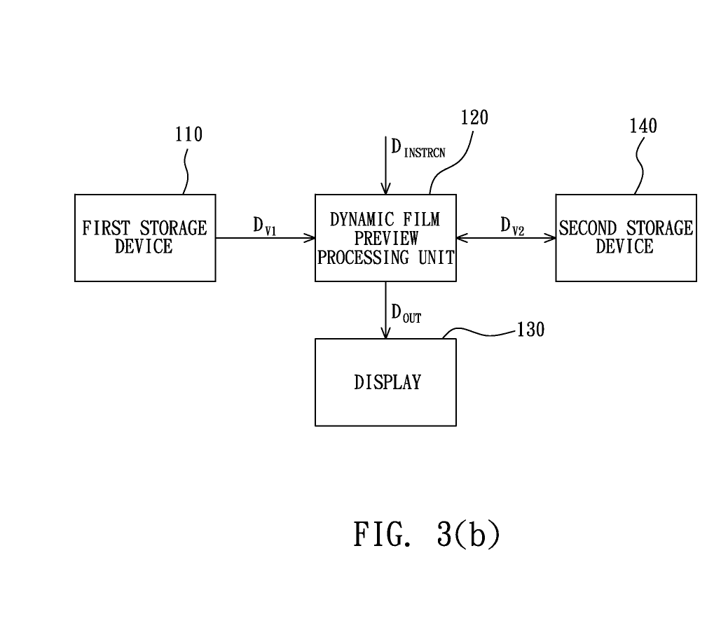

Please refer to FIG. 3(a), which illustrates the block diagram of an apparatus for dynamic film preview on an e-book according to a preferred embodiment of the present invention. As illustrated in FIG. 3(a), the apparatus for dynamic film preview has a first storage device 110, a dynamic film preview processing unit 120, and a display 130.

The first storage device 110, for example but not limited to a hard disk device or a solid state storage device, has a storage space for at least one film.

The dynamic film preview processing unit 120 has the functions as follows: reading a target film D_{V1} from the first storage device 110; fetching a plurality of pictures from the target film D_{V1} to set up a preview figure file D_{V2} and a preview object, wherein the preview figure file D_{V2} contains the plurality of pictures, and the preview object is a display component containing an access route information for reaching the preview figure file D_{V2}; storing the preview figure file D_{V2} in the first storage device 110; and outputting a corresponding image data D_{OUT} to the display 130 so as to display a picture of the preview figure file D_{V2} on a background, and then display the pictures of the preview figure file D_{V2} in an order, which can be sequential or not sequential.

Preferably, the preview object further contains an access route information for reaching the target film D_{V1}, so as to make the dynamic film preview processing unit 120 further possess a function: playing the target film when receiving a selection instruction D_{INSTRCN} for selecting the preview object, wherein the selection instruction d_{INSTRCN} can be generated by operating a mouse, a keyboard, or a touch screen. In addition, the dynamic film preview processing unit 120 makes the target film played in an area of a preferred size.

Besides, as the dynamic film preview mechanism of the present invention doesn't occupy much system resources, therefore, multiple films can be previewed simultaneously on a same page.

Besides, the dynamic film preview processing unit 120 preferably includes a central processing unit, and an operation system which can be WINDOWS [symbol] UNIX [symbol] LINUX [symbol] MacOS [symbol] iOS [symbol] or Android.

Besides, the display 130 can be a CRT display, a liquid crystal display, a plasma display, or an e-paper display.

Please refer to FIG. 3(b), which illustrates the block diagram of an apparatus for dynamic film preview on an e-book according to another preferred embodiment of the present invention. As illustrated in FIG. 3(b), the apparatus for dynamic film preview has a first storage device 110, a dynamic film preview processing unit 120, a display 130, and a second storage device 140.

The first storage device 110, for example but not limited to a hard disk device or a solid state storage device, is used for storing at least one film.

The dynamic film preview processing unit 120 has the functions as follows: reading a target film D_{V1} from the first storage device 110; fetching a plurality of pictures from the target film D_{V1} to set up a preview figure file D_{V2} and a preview object, wherein the preview figure file D_{V2} contains the plurality of pictures, and the preview object is a display component containing an access route information for reaching the preview figure file D_{V2}; storing the preview figure file D_{V2} in the second storage device 140; and outputting a corresponding image data D_{OUT} to the display 130 so as to display a picture of the preview figure file D_{V2} on a background, and then display the pictures of the preview figure file D_{V2} in an order, which can be sequential or not sequential.

Preferably, the preview object further contains an access route information for reaching the target film D_{V1}, so as to make the dynamic film preview processing unit 120 further possess a function: playing the target film when receiving a selection instruction D_{INSTRCN} for selecting the preview object, wherein the selection instruction D_{INSTRCN} can be generated by operating a mouse, a keyboard, or a touch screen. In addition, the dynamic film preview processing unit 120 makes the target film displayed in an area of a preferred size.

Besides, as the dynamic film preview mechanism of the present invention doesn't occupy much system resources, therefore, multiple films can be previewed simultaneously on a same page.

Besides, the dynamic film preview processing unit 120 preferably includes a central processing unit, and an operation system which can be WINDOWS [symbol] UNIX [symbol] LINUX [symbol] MacOS [symbol] iOS [symbol] or Android.

The display 130 can be a CRT display, a liquid crystal display, a plasma display, or an e-paper display.

Besides, the second storage device 140, for example but not limited to a hard disk device or a solid state storage device, is used for storing the preview figure file D_{V2}.

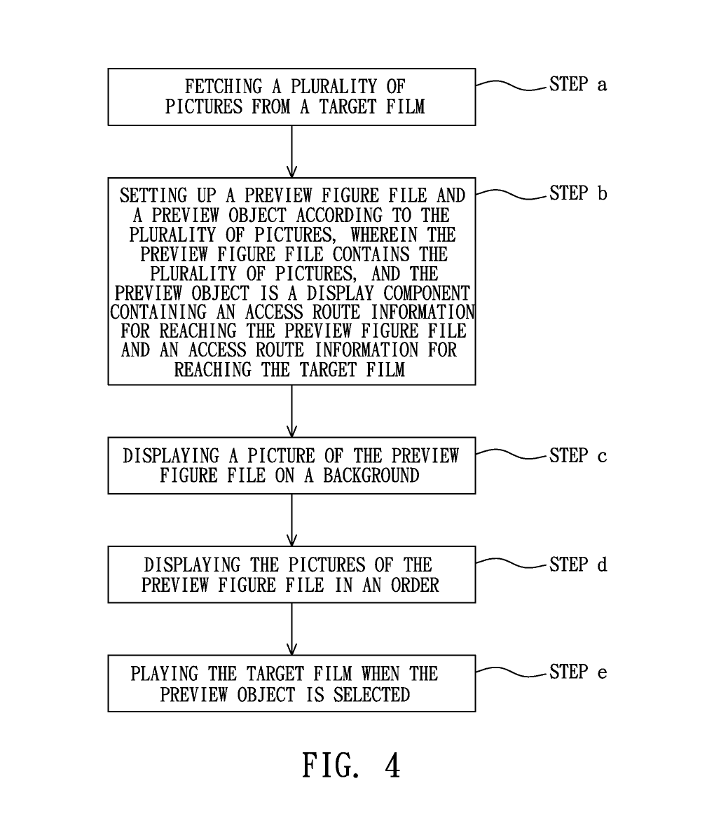

Based on the foregoing specification, the present invention further proposes a method for dynamic film preview on an e-book. Please refer to FIG. 4, which illustrates the flowchart of the method according to a preferred embodiment of the present invention. As illustrated in FIG. 4, the method includes the steps of: fetching a plurality of pictures from a target film (step a); setting up a preview figure file and a preview object according to the plurality of pictures, wherein the preview figure file contains the plurality of pictures, and the preview object is a display component containing an access route information for reaching the preview figure file and an access route information for reaching the target film (step b); displaying a picture of the preview figure file on a background (step c); displaying the pictures of the preview figure file in an order (step d); and playing the target film when the preview object is selected (step e).

In step a, the target film is stored in a first storage device, which can be a hard disk device or a solid state storage device. Besides, the plurality of pictures can be fetched from the target film at a fixed interval (for example fetching one picture per 0.5 second) or at a variable interval.

In step b, the preview figure file can be stored in the first storage device or in a second storage device. The second storage device can be a hard disk device or a solid state storage device. Besides, the plurality of pictures are arranged in an order to set up the preview figure file, wherein the order can be sequential (for example: 1st frame, 51st frame, 101st frame, and so on) or not sequential.

In step 3 and step 4, a corresponding image data can be sent to a display to display the pictures of the preview figure file in an order, which can be sequential or not sequential.

In step 5, the present invention's dynamic film preview method plays the target film according to a selection instruction, which can be generated by operating a mouse, a keyboard, or a touch screen; and the target film is played in an area of a preferred size.

Besides, as the dynamic film preview mechanism of the present invention doesn't occupy much system resources, therefore, multiple films can be previewed simultaneously on a same page.

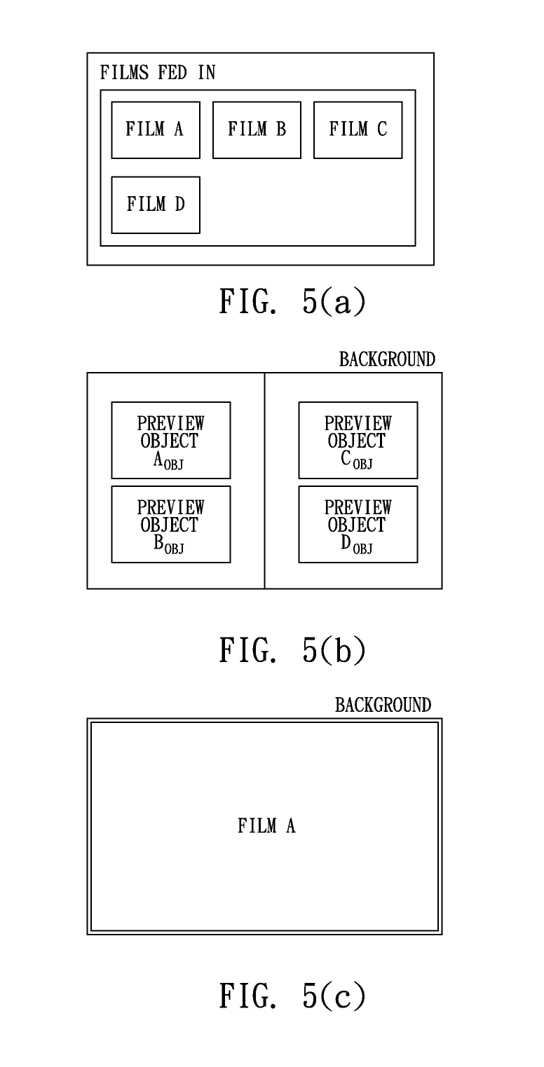

Please refer to FIGS. 5(a), 5(b), and 5(c), which illustrate an operation example of the present invention. FIG. 5(a) indicates that there are film A, film B, film C, and film D fed in the dynamic film preview apparatus of the present invention. FIG. 5(b) indicates that preview object k_{OBJ}, preview object B_{OBJ}, preview object C_{OBJ}, and preview object D_{OBJ} are generated by the dynamic film preview apparatus of the present invention according to film A, film B, film C, and film D, wherein each of the preview objects has an access route information for reaching a corresponding figure file, and automatically displays the pictures of the corresponding figure file in an order, which can be sequential or not sequential. FIG. 5(c) indicates that the dynamic film preview apparatus of the present invention plays film A in response to a user's selection instruction.

The present invention has the following advantages due to its novel design:

1. As the dynamic film preview mechanism of the present invention can change the pictures of a preview object at an interval of time, therefore, a viewer can learn more about the content of the film corresponding to the preview object.

2. As the dynamic film preview mechanism of the present invention changes the pictures of a preview object at an interval of time instead of playing a film, therefore, is capable of saving system resources.

3. As the dynamic film preview mechanism of the present invention doesn't occupy much system resources, therefore, multiple films can be previewed simultaneously on a same page.

4. As the present invention only plays a corresponding film after a preview object is selected, therefore, can provide a tidy, pleasing image on a page when no preview object is selected; and can offer a clear film display quality in response to a user's selection.

5. As the dynamic film preview mechanism of the present invention can be implemented in a general operation system like WINDOWS [symbol] UNIX [symbol] LINUX [symbol] MacOS [symbol] iOS [symbol] or Android, therefore possesses universality.

In conclusion, the dynamic film preview apparatus and method of the present invention can generate a preview figure file and a preview object according to a film, and display the pictures of the preview figure file on a background in an order, and thereby is capable of allowing multiple films to be effectively previewed simultaneously on a same page without occupying much system resources. What's more, the present invention can play a corresponding film in an area of a preferred size after a preview object is selected. The present invention therefore possesses superior advantages.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An apparatus for dynamic film preview on an e-book, comprising:
a first storage device, having a storage space for at least one film; and
a dynamic film preview processing unit, having the functions of: reading a target film from said first storage device; fetching a plurality of pictures from said target film to set up a preview figure file and a preview object, wherein said preview figure file contains said plurality of pictures, and said preview object is a display component containing an access route information for reaching said preview figure file; and displaying the pictures of said preview figure file on a background in an order.

2. The apparatus for dynamic film preview on an e-book as claim 1, wherein said preview object further contains an access route information for reaching said target film, so as to make said dynamic film preview processing unit further possess a function of playing said target film in response to the selection of said preview object.

3. The apparatus for dynamic film preview on an e-book as claim 2, wherein said dynamic film preview processing unit selects said preview object according to a selection instruction, which is generated by operating a mouse, a keyboard, or a touch screen.

4. The apparatus for dynamic film preview on an e-book as claim 1, wherein said first storage device is further used for storing said preview figure files.

5. The apparatus for dynamic film preview on an e-book as claim 4, wherein said first storage device is a hard disk device or a solid state storage device.

6. The apparatus for dynamic film preview on an e-book as claim 4, wherein said dynamic film preview processing unit comprises a central processing unit.

7. The apparatus for dynamic film preview on an e-book as claim 6, wherein said dynamic film preview processing unit comprises an operation system selected from the group consisting of WINDOWS [symbol] UNIX [symbol] LINUX [symbol] MacOS [symbol] iOS [symbol] and Android.

8. An apparatus for dynamic film preview on an e-book, comprising:
a first storage device, used for storing at least one film;
a dynamic film preview processing unit, having the functions of: reading a target film from said first storage device; fetching a plurality of pictures from said target film to set up a preview figure file and a preview object, wherein said preview figure file contains said plurality of pictures, and said preview object is a display component containing an access route information for reaching said preview figure file; and displaying the pictures of said preview figure file on a background in an order; and
a second storage device, used for storing said preview figure files.

9. The apparatus for dynamic film preview on an e-book as claim 8, wherein said preview object further contains an access route information for reaching said target film, so as to make said dynamic film preview processing unit further possess a function of playing said target film in response to the selection of said preview object.

10. The apparatus for dynamic film preview on an e-book as claim 9, wherein said dynamic film preview processing unit selects said preview object according to a selection instruction, which is generated by operating a mouse, a keyboard, or a touch screen.

11. The apparatus for dynamic film preview on an e-book as claim 8, wherein said first storage device is a hard disk device or a solid state storage device.

12. The apparatus for dynamic film preview on an e-book as claim 8, wherein said second storage device is a hard disk device or a solid state storage device.

13. The apparatus for dynamic film preview on an e-book as claim 8, wherein said dynamic film preview processing unit comprises a central processing unit.

14. The apparatus for dynamic film preview on an e-book as claim 8, wherein said dynamic film preview processing unit comprises an operation system selected from the group consisting of WINDOWS [symbol] UNIX [symbol] LINUX [symbol] MacOS [symbol] iOS [symbol] and Android.

15. A method for dynamic film preview on an e-book, the method comprising the steps of:
fetching a plurality of pictures from a target film;
setting up a preview figure file and a preview object according to said plurality of pictures, wherein said preview figure file contains said plurality of pictures, and said preview object is a display component containing an access route information for reaching said preview figure file; and
displaying the pictures of said preview figure file on a background in an order.

16. The method for dynamic film preview on an e-book as claim 15, wherein said preview object further contains an access route information for reaching said target film, so as to have said target film played when said preview object is selected.

17. The apparatus for dynamic film preview on an e-book as claim 16, wherein said preview object is selected according to a selection instruction, which is generated by operating a mouse, a keyboard, or a touch screen.
